(19) United States
(12) Patent Application Publication
(10) Pub. No.: US 2013/0218933 A1
(43) Pub. Date: Aug. 22, 2013

(54) CONSISTENT SELECTIVE SUB-HIERARCHICAL SERIALIZATION AND NODE MAPPING

(71) Applicants: Vadim Ismailov, Holtsville, NY (US); George Economos, Bayport, NY (US)

(72) Inventors: Vadim Ismailov, Holtsville, NY (US); George Economos, Bayport, NY (US)

(73) Assignee: MICROSOFT CORPORATION, Redmond, WA (US)

(21) Appl. No.: 13/400,453

(22) Filed: Feb. 20, 2012

(51) Int. Cl. G06F 7/00

(52) U.S. Cl. 707/812; 707/E17.127

(57) ABSTRACT

An object hierarchy corresponds with a serialized file. The object hierarchy is generated from the serialized file by a generation tool. Non-root objects are attributed with an entity type, namespace, name, and link to their parent object. When an object changes, serialization layer code builds an XPath and produces a partial serialization for local and/or remote users while avoiding the overhead of re-serializing the entire changed hierarchy. The updated serialization may be granular or may include the entire hierarchy. Two users may authorize chronologically overlapping changes to different objects with neither user locking out the other user. Each user receives a respective corresponding updated serialization (granular or non-granular) of the object hierarchy without causing a full re-serialization overhead. A modified object is mapped to an XPath-compatible location in a serialization of the hierarchy. Relationships between individual objects and their properties, and between objects, are maintained when creating the serialization.

### COPYRIGHT AUTHORIZATION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Serialization converts information from a data structure into a format that can be more easily stored and/or transmitted. The data structure is typically in a volatile memory such as in the RAM of a particular computer system. The serialized information may then be stored in a file and/or be transmitted across a network to some other computer system(s). Some forms of serialization provide human-readable versions of information for use when a data structure residing in RAM is in a less accessible binary form. The serialization can be used later in the same computer system and/or in another computer system to create a version of the data structure which matches (at least in part) the data structure that was serialized. The process of serializing an object is sometimes also called deflating or marshalling the object. Deserialization is an opposing operation, in that it builds a data structure in volatile memory (in the original system and/or in another computer system) using information that is read from a serialization. Deserialization is sometimes also called inflating or unmarshalling.

### SUMMARY

Although serialization is widely used, it sometimes imposes undesirable overhead because a large amount of data in a data structure is serialized even when it has not been changed from the last time the data structure was serialized. However, some embodiments described herein provide more focused and efficient approaches to serialization.

From an architectural perspective, some embodiments include a logical processor and a memory in operable communication with the logical processor. An object hierarchy generation tool in the memory has code that is executable by the logical processor. A serialized file in the memory has entities which represent objects in a serialized form. An object hierarchy in the memory corresponds with the serialized file. The object hierarchy is generated from the serialized file by execution of the object hierarchy generation tool code.

In some embodiments, the object hierarchy contains a root object and at least one non-root object. Each non-root object has at least the following allocated attributes: an entity type (namely, the type of serialized entity from which the object was generated), a namespace, a name, and a link to a parent object. The link attributes may be initialized by link initialization code so that each non-root object includes a reference to its parent object in the object hierarchy. Links from parent to child nodes in the object hierarchy are also present.

Some embodiments include object monitor code which monitors an object in the object hierarchy and receives a notice when the object is changed. Some include XPath representation code which builds an XPath-compatible representation of a path from the root object to a specified non-root object in the object hierarchy. Some include partial serialization code which produces a partial serialization (e.g., a serialization that serializes only a specified non-root object of the object hierarchy) and also writes the partial serialization into a pre-existing serialization of the other objects of the object hierarchy. The link initialization, object monitor, XPath representation, and partial serialization codes are listed separately here for clarity, but in a given implementation their functionalities may blend through being placed in one or more procedures, modules, threads, and so on. For example, in some embodiments these codes are all part of a serialization layer.

From a user experience perspective, some embodiments provide partial serialization. A user authorizes (and thus requests) a change to an object in an object hierarchy which resides in a memory (a local memory, or a memory remote from the user's device). The authorized change produces a changed object hierarchy by creating a property of the object, removing a property of the object, updating a property value of the object, adding the object, and/or deleting the object. The user then receives (from the local device or remotely such as over a network) a corresponding updated serialization of at least part of the object hierarchy. Notably, the serialization update does not cause a full re-serialization overhead, namely, it avoids the overhead that would result from a re-serialization of the entire changed object hierarchy.

In some cases and some embodiments, the user receives an updated serialization that includes a serialization of the entire changed object hierarchy. The partial serialization may be inserted in a previously made serialization of the unchanged hierarchy, so the full re-serialization overhead can still be avoided even if an entire hierarchy's serialization is being provided. In other situations, however, the updated serialization received is granular rather than including the entire changed object hierarchy. For example, a user may desire only the serialized form of updates to a particular object or a particular set of objects, especially when those objects belong to a hierarchy containing dozens or even hundreds of other objects that were not changed by the user's request.

In some embodiments, it may happen that two users authorize chronologically overlapping changes to different objects with neither user locking out the other user. Each user receives a respective corresponding updated serialization (granular or non-granular) of the object hierarchy without causing a full re-serialization overhead.

In some cases and some embodiments, the user authorizes the change through a local device which is connectable through a network to the computer in which the code produces a changed object hierarchy. In some, the user receives the updated serialization at a local device which is connectable through a network to the computer in which the code produces a changed object hierarchy.

Some embodiments perform selective sub-hierarchical serialization and/or node mapping. For example, some computationally obtain an object hierarchy which contains a root object and at least one non-root object, e.g., by receiving a memory address pointing to the root object. Each non-root object has attributes such as an entity type, a namespace, a name, and a link to a parent object. Some of these embodiments create a selective sub-hierarchical serialization, namely, a serialization of a selected proper subset of the object hierarchy. Some create a mapping of a non-root object of the hierarchy to an XPath-compatible location in a serialization of the hierarchy; the mapping may be used in a serialization or it may be used locally without being transmitted, e.g., by merely being displayed locally. In general, relationships are present in the object hierarchy between individual objects and respective properties of those objects, and some embodiments are consistent in that creating the serialization and/or the mapping maintains those relationships in the resulting creation.

Some embodiments computationally generate the object hierarchy from an XML serialization of the object hierarchy; some generate the hierarchy from another serialization. In some, the generated object hierarchy includes as objects class instances in a programming language which has static typing; in some, the programming language also supports reflection. Some embodiments computationally monitor objects in the object hierarchy, e.g., by using callbacks, messages, or other computational mechanisms. Some embodiments proactively computationally create the selective sub-hierarchical serialization for a changed object in response to a change detected by the monitoring, and some proactively computationally create the mapping to an XPath-compatible location for a changed non-root object in response to a detected change. Some embodiments change respective objects in the hierarchy for at least two concurrent users without giving either user an exclusive lock on the hierarchy, and computationally create for each user a respective granular selective sub-hierarchical serialization.

Some embodiments run an object hierarchy generation tool to generate the object hierarchy. Some utilize a serialization layer to facilitate partial serialization of the object hierarchy, e.g., by using code in the serialization layer to detect a change, to create the mapping to an XPath-compatible location for a changed object, and to granularly serialize the changed object (including its XPath information).

The examples given are merely illustrative. This Summary is not intended to identify key features or essential features of the claimed subject matter, nor is it intended to be used to limit the scope of the claimed subject matter. Rather, this Summary is provided to introduce—in a simplified form—some concepts that are further described below in the Detailed Description. The innovation is defined with claims, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating a computer system having at least one processor, at least one memory, objects for one or more applications, and other items in an operating environment which may be present on multiple network nodes, and also illustrating configured storage medium embodiments;

FIG. 2 is a block diagram illustrating aspects of consistent selective sub-hierarchical serialization and node mapping in an example architecture;

FIG. 3 is a flow chart illustrating steps of some process and configured storage medium embodiments; and

FIG. 4 includes on the left side a block diagram illustrating an object hierarchy and on the right side a serialization of the object hierarchy, with annotations illustrating aspects of consistent selective sub-hierarchical serialization and node mapping.

### DETAILED DESCRIPTION

Overview

Many applications use XML technology to store and access application data. One familiar way of dealing with XML data is to leverage existing tools such as the XML schema definition tool xsd.exe from Microsoft® Corporation (mark of Microsoft) to translate XML schema (XSD files) into generated source code. This approach helps ensure type safety and data integrity, by abstracting business logic from underlying data format, and helps eliminate efforts that would otherwise be spent developing code to read/write/parse/validate XML.

However, a drawback of this approach may be experienced when some object(s) in a deserialized object hierarchy get modified and the entire object graph is serialized back to XML in order to persist the change(s). Due to the hierarchical nature of XML documents, a deserialized object will involve a hierarchy. Existing frameworks lack adequate mechanisms to allow serialization of only the modified data. Classes generated from XSD by existing tools lack sufficient information identifying their location in the XML document they were deserialized from, and lack sufficient information about their relations to other objects. As result, when a single object is modified at runtime, the entire object tree (which can contain an arbitrarily large number of objects) is re-serialized.

In hindsight, such re-serialization may have several negative aspects. One negative aspect is the overhead of serializing a potentially large object tree (a.k.a. hierarchy) instead of just one or few objects in this tree. Another negative aspect is the risk of increased contention in situations when multiple consumers are reading/writing data. Serializing an entire object tree each time a single change is made involves locking the entire document to prevent clients from reading/writing other parts of the document even if the other parts are not affected by the change.

Another potential negative aspect is that in some situations consumers want to receive granular notifications about changes. For example, suppose product configuration is stored in XML format, and a number of services are listening for configuration changes that are relevant for that service so the changes will take effect without restarting service(s). To implement this functionality efficiently, one cannot leverage existing tools and generated code that do not allow granular (partial) serialization of XML, and as result granular notifications are not utilized. Instead, each service responds to every change notification and analyzes an entire configuration in order to determine what has changed and whether the change is relevant to that service. Although one alternative is to write custom code (instead of generating code), that choice can bring in a host of other problems.

Happily, some embodiments described herein provide consistent selective sub-hierarchical serialization and node mapping. In this context, “selective sub-hierarchical serialization” indicates that a selected subset of an object hierarchy can be serialized, instead of requiring that the entire object hierarchy be serialized. The subset can be any individual object of the hierarchy (objects are also called “nodes”). Two or more selected objects can also be serialized without serializing the entire object hierarchy, regardless of whether the selected objects form a sub-tree in the hierarchy, by applying the selective sub-hierarchical serialization to each selected object in turn. “Node mapping” indicates that each object (node) can be mapped to an XPath-compatible location in a serialization of the object's hierarchy. “Consistent” indicates that the relationships between individual objects of an object hierarchy, and the properties of the objects, are maintained when performing selective sub-hierarchical serialization and node mapping.

Some embodiments provide automatic mapping of an arbitrary node in deserialized object hierarchy to its XPath location in an XML document containing the serialized hierarchy. Some maintain the exact relation between individual objects (and their properties) in an object hierarchy as within the XML document (XSD schema) this object hierarchy was deserialized from. Some embodiments provide partial serialization of an arbitrary object in a hierarchy. This allows one to avoid serialization of the entire object hierarchy, which saves computational resources and enables desired scenarios such as concurrent edits to objects in different parts of the hierarchy.

Some embodiments described herein may be viewed in a broader context. For instance, concepts such as serialization, deserialization, code generation, objects, hierarchies, data types, notices, and/or networks may be relevant to a particular embodiment. However, it does not follow from the availability of a broad context that exclusive rights are being sought herein for abstract ideas; they are not. Rather, the present disclosure is focused on providing appropriately specific embodiments. Other media, systems, and methods involving serialization, deserialization, code generation, objects, hierarchies, data types, notices, and/or networks are outside the present scope. Accordingly, vagueness and accompanying proof problems are also avoided under a proper understanding of the present disclosure.

Reference will now be made to exemplary embodiments such as those illustrated in the drawings, and specific language will be used herein to describe the same. But alterations and further modifications of the features illustrated herein, and additional applications of the principles illustrated herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage, in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise their right to their own lexicography. Terms may be defined, either explicitly or implicitly, here in the Detailed Description and/or elsewhere in the application file.

As used herein, a “computer system” may include, for example, one or more servers, motherboards, processing nodes, personal computers (portable or not), personal digital assistants, cell or mobile phones, other mobile devices having at least a processor and a memory, and/or other device(s) providing one or more processors controlled at least in part by instructions. The instructions may be in the form of firmware or other software in memory and/or specialized circuitry. In particular, although it may occur that many embodiments run on workstation or laptop computers, other embodiments may run on other computing devices, and any one or more such devices may be part of a given embodiment.

A “multithreaded” computer system is a computer system which supports multiple execution threads. The term “thread” should be understood to include any code capable of or subject to scheduling (and possibly to synchronization), and may also be known by another name, such as “task,” “process,” or “coroutine,” for example. The threads may run in parallel, in sequence, or in a combination of parallel execution (e.g., multiprocessing) and sequential execution (e.g., time-sliced). Multithreaded environments have been designed in various configurations. Execution threads may run in parallel, or threads may be organized for parallel execution but actually take turns executing in sequence. Multithreading may be implemented, for example, by running different threads on different cores in a multiprocessing environment, by time-slicing different threads on a single processor core, or by some combination of time-sliced and multi-processor threading. Thread context switches may be initiated, for example, by a kernel's thread scheduler, by user-space signals, or by a combination of user-space and kernel operations. Threads may take turns operating on shared data, or each thread may operate on its own data, for example.

A “logical processor” or “processor” is a single independent hardware thread-processing unit, such as a core in a simultaneous multithreading implementation. As another example, a hyperthreaded quad core chip running two threads per core has eight logical processors. Processors may be general purpose, or they may be tailored for specific uses such as graphics processing, signal processing, floating-point arithmetic processing, encryption, I/O processing, and so on.

A “multiprocessor” computer system is a computer system which has multiple logical processors. Multiprocessor environments occur in various configurations. In a given configuration, all of the processors may be functionally equal, whereas in another configuration some processors may differ from other processors by virtue of having different hardware capabilities, different software assignments, or both. Depending on the configuration, processors may be tightly coupled to each other on a single bus, or they may be loosely coupled. In some configurations the processors share a central memory, in some they each have their own local memory, and in some configurations both shared and local memories are present.

“Kernels” include operating systems, hypervisors, virtual machines, BIOS code, and similar hardware interface software.

“Code” means processor instructions, data (which includes constants, variables, and data structures), or both instructions and data.

“Program” is used broadly herein, to include applications, kernels, drivers, interrupt handlers, libraries, and other code written by programmers (who are also referred to as developers).

“Process” is sometimes used herein as a term of the computing science arts, and in that sense encompasses resource users, namely, coroutines, threads, tasks, interrupt handlers, application processes, kernel processes, procedures, and object methods, for example. “Process” is also used herein as a patent law term of art, e.g., in describing a process claim as opposed to a system claim or an article of manufacture (configured storage medium) claim. Those of skill will understand which meaning is intended in a particular instance, and will also understand that a given claimed process (in the patent law sense) may be implemented using one or more processes (in the computing science sense).

“Automatically” means by use of automation (e.g., general purpose computing hardware configured by software for specific operations discussed herein), as opposed to without automation. In particular, steps performed “automatically” are not performed by hand on paper or in a person's mind; they are performed with a machine.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise beyond the scope of human performance alone. “Computational steps” are steps performed computationally. Neither “automatically” nor “computationally” necessarily means “immediately”.

“Proactively” means without a direct request from a user. Indeed, a user may not even realize that a proactive step by an embodiment was possible until a result of the step has been presented to the user. Except as otherwise stated, any computational and/or automatic step described herein may also be done proactively.

Throughout this document, use of the optional plural “(s)”, “(es)”, or “(ies)” means that one or more of the indicated feature is present. For example, “processor(s)” means “one or more processors” or equivalently “at least one processor”.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a step involving action by a party of interest such as adding, allocating, authorizing, building, causing, changing, containing, creating, deleting, deserializing, detecting, executing, generating, giving, having, including, initializing (i.e., setting or resetting), linking, locking, maintaining, mapping, monitoring, obtaining, producing, receiving, removing, representing, residing, running, serializing, updating, utilizing, writing (and adds, added, allocates, allocated, etc.) with regard to a destination or other subject may involve intervening action such as forwarding, copying, uploading, downloading, encoding, decoding, compressing, decompressing, encrypting, decrypting, authenticating, invoking, and so on by some other party, yet still be understood as being performed directly by the party of interest.

Whenever reference is made to data or instructions, it is understood that these items configure a computer-readable memory and/or computer-readable storage medium, thereby transforming it to a particular article, as opposed to simply existing on paper, in a person's mind, or as a transitory signal on a wire, for example. Unless expressly stated otherwise in a claim, a claim does not cover a signal per se. A memory or other computer-readable medium is presumed to be non-transitory unless expressly stated otherwise.

Operating Environments

With reference to FIG. 1, an operating environment 100 for an embodiment may include a computer system 102. The computer system 102 may be a multiprocessor computer system, or not. An operating environment may include one or more machines in a given computer system, which may be clustered, client-server networked, and/or peer-to-peer networked. An individual machine is a computer system, and a group of cooperating machines is also a computer system. A given computer system 102 may be configured for end-users, e.g., with applications, for administrators, as a server, as a distributed processing node, and/or in other ways.

Human users 104 may interact with the computer system 102 by using displays, keyboards, and other peripherals 106, via typed text, touch, voice, movement, computer vision, gestures, and/or other forms of I/O. System administrators, developers, engineers, and end-users are each a particular type of user 104. Automated agents, scripts, playback software, and the like acting on behalf of one or more people may also be users 104. Storage devices and/or networking devices may be considered peripheral equipment in some embodiments. Other computer systems not shown in FIG. 1 may interact with the computer system 102 or with another system embodiment using one or more connections to a network 108 via network interface equipment, for example.

The computer system 102 includes at least one logical processor 110. The computer system 102, like other suitable systems, also includes one or more computer-readable non-transitory storage media 112. Media 112 may be of different physical types. The media 112 may be volatile memory, non-volatile memory, fixed in place media, removable media, magnetic media, optical media, and/or of other types of non-transitory media (as opposed to transitory media such as a wire that merely propagates a signal). In particular, a configured medium 114 such as a CD, DVD, memory stick, or other removable non-volatile memory medium may become functionally part of the computer system when inserted or otherwise installed, making its content accessible for use by processor 110. The removable configured medium 114 is an example of a computer-readable storage medium 112. Some other examples of computer-readable storage media 112 include built-in RAM, ROM, hard disks, and other memory storage devices which are not readily removable by users 104. Unless expressly stated otherwise, neither a computer-readable medium nor a computer-readable memory includes a signal per se.

The medium 114 is configured with instructions 116 that are executable by a processor 110; “executable” is used in a broad sense herein to include machine code, interpretable code, and code that runs on a virtual machine, for example. The medium 114 is also configured with data 118 which is created, modified, referenced, and/or otherwise used by execution of the instructions 116. The instructions 116 and the data 118 configure the medium 114 in which they reside; when that memory is a functional part of a given computer system, the instructions 116 and data 118 also configure that computer system. In some embodiments, a portion of the data 118 is representative of real-world items such as product characteristics, inventories, physical measurements, settings, images, readings, targets, volumes, and so forth. Such data is also transformed by backup, restore, commits, aborts, reformatting, serialization, partial serialization, node mapping, hierarchy generation, and/or other operations.

An application 120 with objects 122 having properties 124, other software, and other items shown in the Figures and/or discussed in the text, may each reside partially or entirely within one or more media 112, thereby configuring those media. Serialized files 126, such as XML serializations of objects 122, may reside in the system's memory 112. In addition to display(s) 128, an operating environment may also include other hardware, such as buses, power supplies, wired and wireless network interface cards, and accelerators, for instance.

A given operating environment 100 may include an Integrated Development Environment (IDE) 130 which provides a developer with a set of coordinated software development tools 132 such as compilers, source code editors, profilers, debuggers, and so on. In particular, some of the suitable operating environments for some embodiments include or help create a Microsoft® Visual Studio® development environment (marks of Microsoft Corporation) configured to support program development. Some suitable operating environments include Java® environments (mark of Oracle America, Inc.), and some include environments which utilize languages such as C++ or C# (“C-Sharp”), but teachings herein are applicable with a wide variety of programming languages, programming models, and programs, as well as with endeavors outside the field of software development per se that use objects, serialization, or both.

One or more items are shown in outline form in FIG. 1 to emphasize that they are not necessarily part of the illustrated operating environment, but may interoperate with items in the operating environment as discussed herein. It does not follow that items not in outline form are necessarily required, in any Figure or any embodiment.

Systems

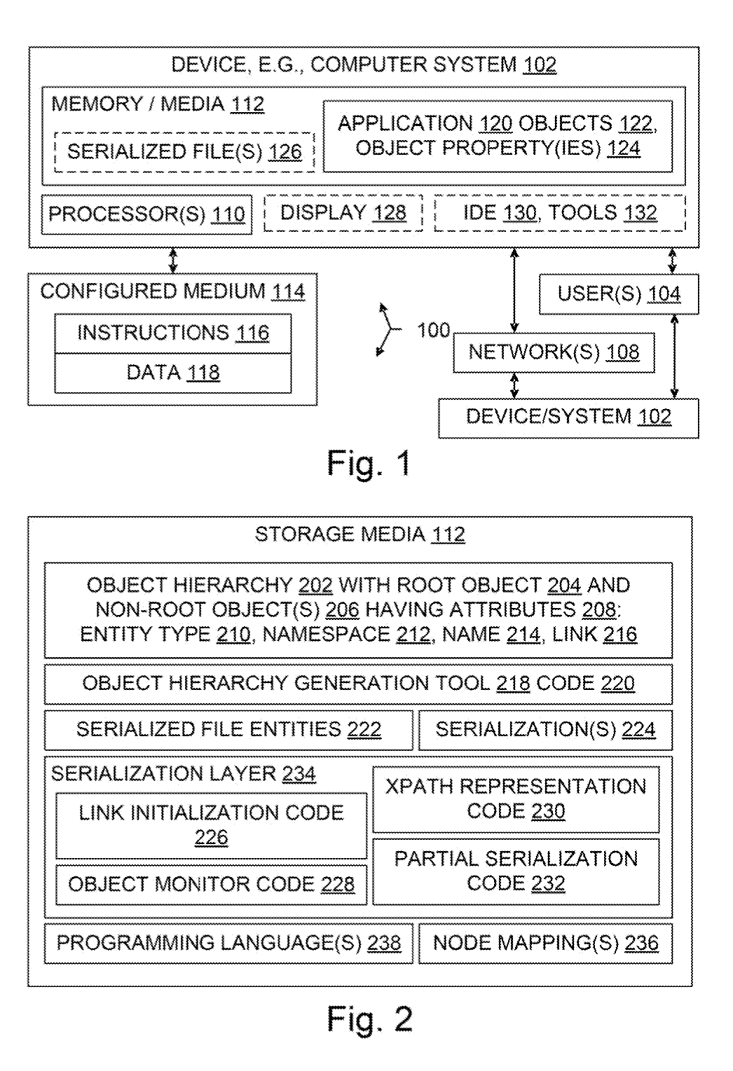

FIG. 2 illustrates an architecture which is suitable for use with some embodiments. An object hierarchy (a.k.a. tree) 202 includes a root object 204, 122 and non-root objects 206, 122 which directly or indirectly depend from the root object in hierarchical fashion. Although the hierarchy includes a tree, it may also include additional links as part of a graph which (taken as a whole) is not strictly a tree. That is, the hierarchy may be embedded within a larger data structure that is not as a whole strictly hierarchical, although the focus herein is on the hierarchical portion of that larger data structure. The link attributes 216 may be initialized by link initialization code 226 so that each non-root object includes a reference to its parent object in the object hierarchy. As used here, “initialized” simply means that a meaningful or useful value is present in a link, and is not limited to the first such value ever written. Links from parent to child nodes in the object hierarchy may also be present.

In some embodiments, the objects 122 have attributes 208. Attributes 208 may be implemented as properties 124 or implemented using a separate attribute mechanism. For example, in some embodiments attributes 208 are a class's variables whereas properties are routines or methods for interacting (e.g., set/write value, get/read value) with those variables. In some embodiments, each object 122 has among its attributes 208 an entity type 210, a namespace 212, a name 214, and (with the exception of the root object 204 that has no parent) a link 216 to its parent object in the hierarchy. An attribute may be implemented using storage within the object 122 itself; this implementation would normally be used for the parent link 216 and the name 214, and would often be used for entity type 210. An attribute may also be inherited from a parent or other ancestor object, e.g., an object 206 may inherit a value specifying its namespace 212. Attributes applying to many or all objects may also be specified in a global variable, e.g., namespace 212 could be implemented as a global attribute. In some embodiments, the name 214 is a qualified name, i.e., it includes at least a portion of a path leading to the named object 206.

Some embodiments include a logical processor 110 and a memory 112 in operable communication with the logical processor. An object hierarchy generation tool 218 in the memory has code 220 that is executable by the logical processor 110. A serialized file 126 in the memory has entities 222 which represent objects 122 in a serialized form. The object hierarchy 202 in the memory corresponds with the serialized file 126; the file 126 includes a serialization 224 of the hierarchy and its objects. The object hierarchy 202 is generated from the serialized file by execution of the object hierarchy generation tool code 220.

Some embodiments include object monitor code 228 which monitors an object 122 in the object hierarchy and receives a notice when the object is changed. Some include XPath representation code 230 which builds an XPath-compatible representation of a path (a node mapping 236) from the root object 204 to a specified non-root object 206 in the object hierarchy. Some include partial serialization code 232 which produces a partial serialization (e.g., a serialization that serializes only information pertaining to a specified non-root object 206 of the object hierarchy) and also writes the partial serialization into a pre-existing serialization 224 of the other objects of the object hierarchy. The link initialization, object monitor, XPath representation, and partial serialization codes 226-232 are listed separately here for clarity, but in a given implementation their functionalities may blend through being placed in one or more procedures, modules, threads, and so on. For example, in some embodiments these codes 226-232 are all part of a serialization layer 234. The codes 226-232 are sometimes referred to herein as “helper” routines or as part of a “helper library”.

In some embodiments, an object 206 is an instance of a class. Classes are generated by the code generation tool 218. The structure of a class (name, what properties it has, the type of these properties, etc.) is determined by a schema such as an XSD file, which the code generation tool uses as an input. This technology could be used with various programming languages 238 (C/C++, C#, Java, Objective-C, etc.) by adding language support to the code generator tool 218 and implementing a helper library with one or more of codes 226-232 for the language 238. One still iterates over instances of objects (data structures) in memory 112, whether the programming language 238 has static typing, reflection support, or both.

With reference to FIGS. 1 and 2, some embodiments provide a computer system 102 with a logical processor 110 and a memory medium 112 configured by circuitry, firmware, and/or software to transform data by serialization and/or deserialization as described herein. Some include an object hierarchy generation tool 218 residing in the memory 112 and having code 220 executable by the logical processor, a serialized file 126 residing in the memory and having entities 222 which represent objects 122 in a serialized form, and an object hierarchy 202 corresponding with the serialized file and generated from the serialized file by execution of the object hierarchy generation tool code. The object hierarchy 202 contains a root object 204 and at least one non-root object 206, each non-root object having at least the following allocated attributes: an entity type 210 (namely, the type of serialized entity from which the object was generated), a namespace 212, a name 214, a link 216 to a parent object.

In some embodiments, the link attributes are initialized in addition to being allocated. That is, the link attributes have been written (or overwritten) with values that allow traversal of a path from the non-root object up to the root object. Some embodiments include link initialization code 226 which resides in the memory and which upon execution by the logical processor 110 initializes values of link attributes such that each non-root object 206 includes a reference (pointer, address, other identifier) to its parent object in the object hierarchy 202.

Some embodiments include object monitor code 228 which resides in the memory and which upon execution by the logical processor 110 monitors an object 122 in the object hierarchy 202 and receives a notice (message, signal, interrupt, control of processing flow, callback, etc.) when the object is changed.

Some embodiments include XPath representation code 230 which resides in the memory and which upon execution by the logical processor builds an XPath-compatible representation of a path from the root object 204 to a specified non-root object 206 in the object hierarchy (and/or a path in the reverse direction, since paths are reversible and thus equivalent for present purposes). Those of skill will recognize that XPath is commercially available as a query language for selecting nodes from an XML document. As used herein, “XPath-compatible” means compliant with at least one version of XPath.

Some embodiments include partial serialization code 232 which resides in the memory and which upon execution by the logical processor 110 produces a partial serialization which serializes a specified non-root object 206 of the object hierarchy 202 and also optionally writes the partial serialization into a pre-existing serialization 224 of the other objects of the object hierarchy.

In some embodiments peripherals 106 such as human user I/O devices (screen, keyboard, mouse, tablet, microphone, speaker, motion sensor, etc.) will be present in operable communication with one or more processors 110 and memory. However, an embodiment may also be deeply embedded in a system, such that no human user 104 interacts directly with the embodiment. Software processes may be users 104.

In some embodiments, the system includes multiple computers connected by a network. Networking interface equipment can provide access to networks 108, using components such as a packet-switched network interface card, a wireless transceiver, or a telephone network interface, for example, will be present in a computer system. However, an embodiment may also communicate through direct memory access, removable nonvolatile media, or other information storage-retrieval and/or transmission approaches, or an embodiment in a computer system may operate without communicating with other computer systems.

Some embodiments operate in a “cloud” computing environment and/or a “cloud” storage environment in which computing services are not owned but are provided on demand. For example, an object hierarchy 202 may be located on multiple devices/systems 102 in a networked cloud, pre-existing serializations 224 may be stored on yet other devices within the cloud, and the updated serialization (granular or full) may configure the memory(ies) on yet other cloud device(s)/system(s) 102.

Processes

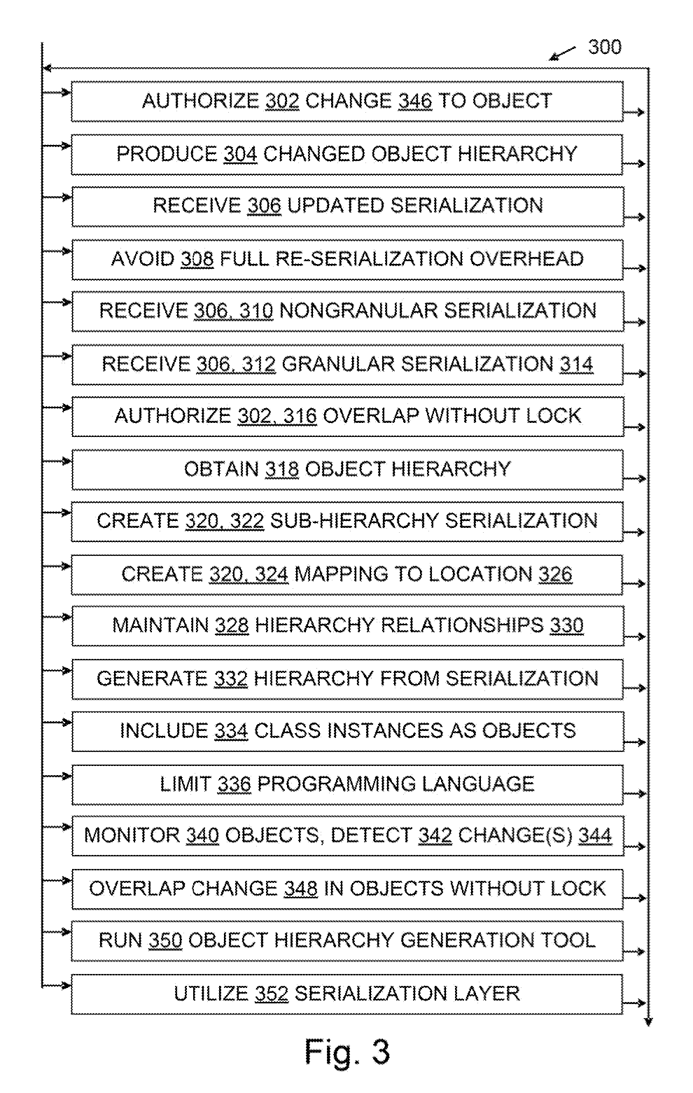

FIG. 3 illustrates some process embodiments in a flowchart 300. Processes shown in the Figures may be performed in some embodiments automatically, e.g., by a code generation tool 218 and/or serialization layer 234 driven by requests from an application 120 under control of a script, a playback mechanism, or otherwise requiring little or no contemporaneous live user input specifically directed at serialization/deserialization. Processes may also be performed in part automatically and in part manually unless otherwise indicated. In a given embodiment zero or more illustrated steps of a process may be repeated, perhaps with different parameters or data to operate on. Steps in an embodiment may also be done in a different order than the top-to-bottom order that is laid out in FIG. 3. Steps may be performed serially, in a partially overlapping manner, or fully in parallel. The order in which flowchart 300 is traversed to indicate the steps performed during a process may vary from one performance of the process to another performance of the process. The flowchart traversal order may also vary from one process embodiment to another process embodiment. Steps may also be omitted, combined, renamed, regrouped, or otherwise depart from the illustrated flow, provided that the process performed is operable and conforms to at least one claim.

Examples are provided herein to help illustrate aspects of the technology, but the examples given within this document do not describe all possible embodiments. Embodiments are not limited to the specific implementations, arrangements, displays, features, approaches, or scenarios provided herein. A given embodiment may include additional or different features, mechanisms, and/or data structures, for instance, and may otherwise depart from the examples provided herein.

From a user experience perspective, some embodiments provide partial serialization. A user 104 authorizes 302 (and thus requests) a change 346 to an object 122 in an object hierarchy 202 which resides in a memory 112. The memory 112 containing the hierarchy may be a local memory (from the user's perspective), or it may be a memory that is remote from the user's device. The authorized change produces 304 a changed object hierarchy. Step 304 may be accomplished, for example, by creating a property 124 of the object, removing a property 124 of the object, updating a property 124 value of the object, adding the object 122 to the hierarchy 202, and/or deleting the object 122. The user 104 then receives 306 (from the user's local device 102 or remotely such as over a network 108) a corresponding updated serialization 224 of at least part of the object hierarchy 202. Notably, the serialization update does not cause (i.e., avoids 308) a full re-serialization overhead. That is, updating the serialization avoids 308 the overhead that would result from a re-serialization of the entire changed object hierarchy.

In some cases and some embodiments, the user receives 306, 310 an updated serialization that includes a serialization of the entire changed object hierarchy. The partial serialization may be inserted in a previously made serialization 224 of the unchanged hierarchy, so the full re-serialization overhead can still be avoided 308 even if an entire hierarchy's serialization is being provided to the user. In other situations, however, the updated serialization received 306, 312 is a granular serialization 314, 224 rather than including the entire changed object hierarchy. For example, a user 104 may desire only the serialized form of updates to a particular object 122 or a particular set of objects 122, especially when those objects belong to a hierarchy 202 containing dozens or even hundreds of other objects not changed 346 by the user's request.

In some embodiments, it may happen that two users authorize 302, 316 chronologically overlapping changes 346 to different objects 122 with neither user locking out the other user. Each user receives a respective corresponding updated serialization 224 (granular or non-granular) of the object hierarchy 202 without causing a full re-serialization overhead.

In some cases and some embodiments, the user authorizes 302 the change through a local device 102 which is connectable through a network 108 to the computer 102 in which the code 220 produces a changed object hierarchy. In some, the user receives 306 the updated serialization at a local device 102 which is connectable through a network 108 to the computer 102 in which the code 220 produces a changed object hierarchy.

Some embodiments perform selective sub-hierarchical serialization and/or node mapping. For example, some computationally obtain 318 an object hierarchy which contains a root object and at least one non-root object, e.g., by receiving a memory address pointing to the root object. Each non-root object 206 has attributes such as an entity type, a namespace, a name, and a link to a parent object. Some of these embodiments create 320, 322 a selective sub-hierarchical serialization, namely, a serialization 224 of a selected proper subset of the object hierarchy. Some create 320, 324 a mapping 236 of a non-root object of the hierarchy to an XPath-compatible location 326 in a serialization 224 of the hierarchy. The node mapping may be used in a serialization and/or it may be used locally without being transmitted, e.g., by merely being displayed locally.

In general, relationships 330 are present in the object hierarchy 202 between individual objects 122 and respective properties 124 of those objects, and between objects 122. Some embodiments are “consistent” in that creating 322 the serialization 224 and/or creating 324 the mapping 236 maintains 328 those relationships in the resulting creation 224, 236.

Some embodiments computationally generate 332 the object hierarchy from an XML serialization of the object hierarchy 202. Some generate 332 the hierarchy from another kind of serialization, such as a non-XML serialization in Notation3, JSON, YAML, property list, or other serialization format. In some, the generated object hierarchy includes 334 as objects 206 class instances in a programming language 238. The programming language 238 may be limited 336 to a language which has static typing and/or which supports reflection.

Some embodiments computationally monitor 340 objects 206 in the object hierarchy, e.g., by using callbacks, messages, or other computational mechanisms. Some embodiments proactively computationally create 322 the selective sub-hierarchical serialization for a changed object 344, 122 in response to a change 346 that is detected 342 by the monitoring, and some proactively computationally create 324 the mapping to an XPath-compatible location for a changed non-root object 344, 206, 122 in response to a detected change. Some embodiments change 346, 348 respective objects in the hierarchy 202 for at least two concurrent users 104 without giving either user an exclusive lock on the hierarchy, and computationally create 322 for each user a respective granular selective sub-hierarchical serialization 314, 224.

Some embodiments run 350 an object hierarchy generation tool 218 to generate 332 the object hierarchy 202. Some utilize 352 a serialization layer 234 to facilitate partial serialization of the object hierarchy. Utilization 352 may include, e.g., using code 228 in the serialization layer to detect 342 a change, using code 230 to create 324 the mapping to an XPath-compatible location for a changed object, and using code 232 to granularly serialize 322 the changed object (including its XPath information).

Configured Media

Some embodiments include a configured computer-readable storage medium 112. Medium 112 may include disks (magnetic, optical, or otherwise), RAM, EEPROMS or other ROMs, and/or other configurable memory, including in particular non-transitory computer-readable media (as opposed to wires and other propagated signal media). The storage medium which is configured may be in particular a removable storage medium 114 such as a CD, DVD, or flash memory. A general-purpose memory, which may be removable or not, and may be volatile or not, can be configured into an embodiment using items such as code or other object hierarchy generations tool(s) 218, one or more serialization layer 234 codes, and/or more fully attributed object hierarchies 202, in the form of data 118 and instructions 116, read from a removable medium 114 and/or another source such as a network connection, to form a configured medium. The configured medium 112 is capable of causing a computer system to perform process steps for transforming data through consistent selective sub-hierarchical serialization and/or consistent node mapping as disclosed herein. FIGS. 1 through 3 thus help illustrate configured storage media embodiments and process embodiments, as well as system and process embodiments. In particular, any of the process steps illustrated in FIG. 3, or otherwise taught herein, may be used to help configure a storage medium to form a configured medium embodiment.

Additional Examples

Additional details and design considerations are provided below. As with the other examples herein, the features described may be used individually and/or in combination, or not at all, in a given embodiment.

Those of skill will understand that implementation details may pertain to specific code, such as specific APIs and specific sample programs, and thus need not appear in every embodiment. Those of skill will also understand that program identifiers and some other terminology used in discussing details are implementation-specific and thus need not pertain to every embodiment. Nonetheless, although they are not necessarily required to be present here, these details are provided because they may help some readers by providing context and/or may illustrate a few of the many possible implementations of the technology discussed herein.

Some embodiments makes possible partial serialization (only serializing modified objects) while leveraging code generation. Some include two major components, namely, a code generation tool 218 and a serialization layer 234. The code generation tool 218 extends technology such as that in the xsd.exe tools, to generate classes from XSD files. Code generated 332 from XSD code contains additional information (custom attributes 208) that can be used to determine the relation 330 of a deserialized object to its location 326 in the XML document 126 from which the object originated (via deserialization). The additional information includes the type 210 of XML entity an object was generated from (element, attribute, array, sequence, etc.), the XML namespace 212, the qualified name 214, and a link 216 to the parent object. This information is used at runtime by the serialization layer 234 as described below.

The serialization layer 234 can be implemented as reusable helper library. This layer 234 is designed to work with objects 204, 206 that were generated 332 by the custom code generation tool 218 described above. This library is responsible for initial instrumentation of the deserialized object graph (link initialization), monitoring of object changes and subsequent serialization of modified objects back to an XML document.

In some embodiments, the code generation component 218 is a stand-alone utility that generates source code 202 from XSD files. All classes and properties in the generated code will have special attributes 208 that will be used at runtime by the helper library 234. When and XML document (based on XSD schema code it was generated from) is deserialized into an object graph 202 in memory 112, the helper library will walk the graph from top to bottom and set references (initialize links 216) such that each object will have reference to its parent (except the root object 204, of course). This way, later on the helper library will be able to walk the hierarchy from any object 206 up to the root object 204.

After setting up references to parent objects, this helper library will also subscribe to property change 346 events in all objects 204, 206 in the hierarchy. From this moment on, whenever an object 204, 206 is modified, added or removed an event will be triggered, detected 342 and handled by the helper library. The helper library will walk the object hierarchy, starting from the object 206 that was modified by the emitted event, all the way up to the root object 204 and build 324 an XPath representation to modify the object representation in an underlying XML file. XPath information will be constructed with the help of special attributes 208 that were created 332 by the code generation tool. Once the XPath representation is constructed, the helper library (still inside event processing in this implementation) will serialize 322 the modified object and write it to the underlying XML document 126.

From the perspective of a user developer, one is dealing with strongly typed objects 122, without any distracting concern to XML or XPath. As an example, consider the following object hierarchy in memory 112 (boldface and italic have been added below to aid this discussion):
Company
   Department A
      User A
      User B
   Department B
      User C
      User D

This object hierarchy was deserialized from an XML document that looks in pertinent part like this:

```
<Company> <Department name=”A”>

[symbol]

    <User name=”B” />
  </Department>
  <Department name=”B”>
    <User name=”C” />
    <User name=”D” />
  </Department>
</Company>
```

When the user object 206 indicated in boldface and italic changes at runtime, an embodiment will be able to map 324 this object to the corresponding XML block in a serialization 224 and update it.

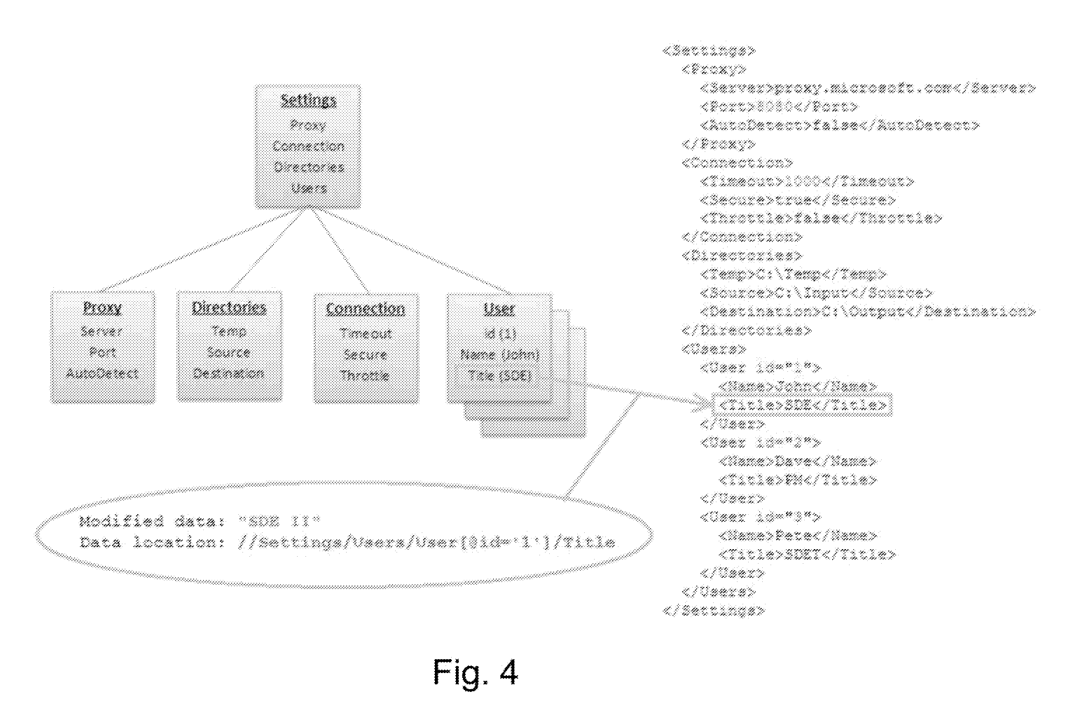

FIG. 4 illustrates the granularity some embodiments provide. For example, a developer may write code that looks like this:
Settings.Users[0].Title=“SDE II”;

The helper library will handle property change events, build correct XPath representations, and update appropriate element(s) in the backend XML store 126. (“XPath”, “XPath fragment”, and “XPath representation” are used interchangeably below.) When a change is detected 342, the innermost object that was modified is serialized and an XPath is created that points to the precise location 326 in the backend XML where a modified XML fragment should be stored. Given the XML fragment (data) and its XPath (location) the helper library 232 will write modified data to the XML document at the exact location where it belongs.

The XPath fragment is built 324 by walking the object hierarchy 202 backwards from the node 206 that was modified to the root object 204, reading and analyzing custom attributes 208 that were generated 332 by the code generation component 218. As noted, during initialization the helper library walked the entire (newly deserialized) object tree 202 and set parent node references on each object 206. References to parent objects are also stored in custom, autogenerated attributes 216.

By way of further illustration, some embodiments include a code generation tool 218 which generates an object hierarchy from a serialized file (e.g., an XML file). The tool 218 includes at least the following attributes for each object 206: type of serialized entity the object was generated from (element, attribute, array, sequence, etc.), namespace, qualified name, link to parent object. The link's value is not necessarily set during code generation, but the other attribute values are set by the code generation tool. The code generation tool allocates space for the links, and the runtime places the values in those allocated spaces.

It will be understood that an XSD file is a schema file that describes what serialized XML should look like: element and attribute names, parent/child relations, various constraints, etc. It is a data contract which describes what an instance of a valid XML document should look like in order to conform to its schema. In some embodiments the code generation tool 218 uses an XSD file to generate code (a class hierarchy) which serializes/deserializes to/from an XML file. Although the data contract is defined by XSD, for serialization, it is possible to use other that XML formats. One can use a relational database (Microsoft® SQL Server® technology, for example, marks of Microsoft Corporation) for storing data described by XSD. It is also possible to implement a custom serializer. However, in many situations using XML serialization is the easiest, most natural approach.

Attributes 208 are used in some embodiments to calculate an XPath representation of a modified object and properly serialize it back. For example, while navigating the object hierarchy (one hop at a time) and building an XPath representation, code is reading attributes of each object in order to build the correct XPath. Consider FIG. 4. In this example, one is modifying the user's title. However, there is more than one user. If one were to simply walk up the hierarchy and build XPath using object names one would end up with this:
//Settings/Users/User/Title
   But this is an invalid XPath because it matches titles of all users. What is desired is this:
//Settings/Users/User[@id=‘1’]/Title
   This attribute “[@id=‘1’ ” uniquely identifies the right user.

Information used to build correct XPath is stored in attributes 208. The /Users object, for example, has attributes indicating that it is an array root and the name of its child array items. The /User object has attributes indicating that it is an array item and that it has a unique key called “id”. Knowledge is provided in attributes of how an object and its properties are mapped to the serialized hierarchy (XML file in this example). Use is made of an element/attribute name, information to distinguish between elements and attributes, information about arrays and sequences, and so on. Using XSD during mapping creation 324 allows one to describe this, and the code generation tool 218 extracts this information and includes it in generated 332 code. Because classes and their properties in the code will not necessarily have same names as elements or attributes in XML, when the code generator 218 is attributing generated code it also stores names 214 in the hierarchy 202 as well.

Shown below is a simplified example of how generated C# code would look in one scenario. The boldface italic attributes contain information used to build the correct XPath discussed above. Per normal practice, web addresses have been disabled by replacing periods with the word “dot”. All web addresses and other internet links shown in this document are meant for illustration only, are not meant to be active links, and are not intended to incorporate any information into this document by reference.

```

[symbol]

[symbol]

[symbol]


public partial class Settings : object,
INotifyPropertyChanged {

[symbol]

[symbol]

[symbol]

[symbol]

[symbol]




    public UserType[ ] Users {
        get {
            return this.usersField;
        }
        set {
            this.usersField = value;
            this.RaisePropertyChanged(“Users”);
        }
    }
}
public partial class UserType : object,
INotifyPropertyChanged {

[symbol]

[symbol]

[symbol]

[symbol]

[symbol]




    public int Id {
        get {
              return this.idField;
        }
    }

[symbol]

[symbol]

[symbol]


    public string Name {
        get {
              return this.nameField;
        }
        set {
              this.nameField = value;
              this.RaisePropertyChanged(“Name”);
        }
    }

[symbol]

[symbol]

[symbol]


    public string Name {
        get {
              return this.titleField;
        }
        set {
              this.titleField = value;
            this.RaisePropertyChanged(“Title”);
        }
    }
}
```

Some embodiments include the code generation tool 218 plus a helper routine 226 that sets the values of link attributes, so that each object except the root includes a reference to its parent object in the object hierarchy. Input to this routine is an object hierarchy generated by the code generation tool. The code generation tool generates code. This generated code 202 plus a number of helper routines 226-232 do work from this point on; the tool 218 itself is not directly involved in subscribing to events or processing events.

Some embodiments include the code generation tool 218, plus a helper routine 228 (implemented with the same routine as link initialization or as a separate routine) that monitors 340 an object in the object hierarchy by subscribing to receive a notice when the object is changed (property value modified, object added, or object removed). Input to this routine is the object ID of the object being monitored. Examples of object IDs include the reference (address in memory) and other ways to identify objects, e.g., handles, key values, indexes in an array, and so on, depending on the particular implementation. It will be understood that these all rely in some way on the object's address in the memory 112.

Some embodiments include the code generation tool 218, plus a helper routine 230 (implemented with the same routine as other code 234 or as a separate routine) that walks the object hierarchy from an identified object up to the root and builds an XPath-compatible representation of the path from the root to the identified object. This routine could be triggered by a change to the identified object, or it could be called independently of any change, e.g., to examine the object hierarchy for whatever reason, e.g., during debugging. Input to this routine is the object ID of the identified object.

Some embodiments include the code generation tool 218, plus a helper routine 232 (implemented with the same routine as other code 234 or as a separate routine) that serializes an identified object and writes the serialization to a pre-existing serialization of the object's hierarchy. Input to this routine is a path representation built by the routine code 230, the pre-existing serialization of the object's hierarchy, and a reference to a modified object, so it can save the changes.

In some embodiments, routines invoked at different times are involved. A routine Alpha that walks the object hierarchy and sets up links to parent objects is invoked when an XML file is read into a memory and deserialized into an object hierarchy 202. All objects in this hierarchy are already attributed (attributes are hardcoded into each class by a code generation tool). The same routine, while walking the hierarchy and setting up links, is also passing an address of another routine Beta into each object. Each class/object contains a piece of code (also generated) that will call routine Beta whenever this object is modified 346. The process of setting up links and subscribing to events is only invoked once. Routine Beta is called each time an object in a hierarchy is modified. It receives a reference to a modified object, walks the object hierarchy using parent links, reads attributes of each object and builds an XPath. Then it calls another routine Gamma (e.g., code 232) in order to persist changes.

Conclusion

Although particular embodiments are expressly illustrated and described herein as processes, as configured media, or as systems, it will be appreciated that discussion of one type of embodiment also generally extends to other embodiment types. For instance, the descriptions of processes in connection with FIG. 3 also help describe configured media, and help describe the operation of systems and manufactures like those discussed in connection with other Figures. It does not follow that limitations from one embodiment are necessarily read into another. In particular, processes are not necessarily limited to the data structures and arrangements presented while discussing systems or manufactures such as configured memories.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific features of an example may be omitted, renamed, grouped differently, repeated, instantiated in hardware and/or software differently, or be a mix of features appearing in two or more of the examples. Functionality shown at one location may also be provided at a different location in some embodiments.

Reference has been made to the figures throughout by reference numerals. Any apparent inconsistencies in the phrasing associated with a given reference numeral, in the figures or in the text, should be understood as simply broadening the scope of what is referenced by that numeral.

As used herein, terms such as “a” and “the” are inclusive of one or more of the indicated item or step. In particular, in the claims a reference to an item generally means at least one such item is present and a reference to a step means at least one instance of the step is performed.

Headings are for convenience only; information on a given topic may be found outside the section whose heading indicates that topic.

All claims and the abstract, as filed, are part of the specification.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific features or acts described above the claims. It is not necessary for every means or aspect identified in a given definition or example to be present or to be utilized in every embodiment. Rather, the specific features and acts described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A computer system comprising:
a logical processor;
a memory in operable communication with the logical processor;
an object hierarchy generation tool residing in the memory and having code executable by the logical processor;
a serialized file residing in the memory and having entities which represent objects in a serialized form; and
an object hierarchy corresponding with the serialized file and generated from the serialized file by execution of the object hierarchy generation tool code, the object hierarchy containing a root object and at least one non-root object, each non-root object having at least the following allocated attributes: an entity type (namely, the type of serialized entity from which the object was generated), a namespace, a name, a link to a parent object.

2. The system of claim 1, wherein the link attributes are initialized in addition to being allocated.

3. The system of claim 1, further comprising link initialization code which resides in the memory and which upon execution by the logical processor initializes values of link attributes such that each non-root object includes a reference to its parent object in the object hierarchy.

4. The system of claim 1, further comprising object monitor code which resides in the memory and which upon execution by the logical processor monitors an object in the object hierarchy and receives a notice when the object is changed.

5. The system of claim 1, further comprising XPath representation code which resides in the memory and which upon execution by the logical processor builds an XPath-compatible representation of a path from the root object to a specified non-root object in the object hierarchy.

6. The system of claim 1, further comprising partial serialization code which resides in the memory and which upon execution by the logical processor produces a partial serialization which serializes a specified non-root object of the object hierarchy and writes the partial serialization into a pre-existing serialization of the other objects of the object hierarchy.

7. A user experience process for partial serialization in a computer system, the computer system having a memory and at least one logical processor, the user experience process comprising the steps of a user:
authorizing a change to an object in an object hierarchy which resides in the computer system's memory by logical processor execution of code which produces a changed object hierarchy by performing at least one of the following: creating a property of the object, removing a property of the object, updating a property value of the object, adding the object, deleting the object; and then
receiving from the computer system a corresponding updated serialization of at least part of the object hierarchy without the process causing a full re-serialization overhead, namely, overhead from re-serialization of the entire changed object hierarchy.

8. The process of claim 7, wherein the updated serialization received includes a serialization of the entire changed object hierarchy.

9. The process of claim 7, wherein the updated serialization received is granular rather than including the entire changed object hierarchy.

10. The process of claim 7, wherein the user authorizes the change through a local device which is connectable through a network to the computer system in which the code produces a changed object hierarchy.

11. The process of claim 7, wherein the user receives the updated serialization at a local device which is connectable through a network to the computer system in which the code produces a changed object hierarchy.

12. The process of claim 7, wherein two users authorize chronologically overlapping changes to different objects with neither user locking out the other user, and wherein each user receives from the computer system a respective corresponding updated serialization of the object hierarchy without causing a full re-serialization overhead.

13. A computer-readable non-transitory storage medium configured with data and with instructions that when executed by at least one processor causes the processor(s) to perform a process for selective sub-hierarchical serialization and node mapping, the process comprising the computational steps of:
obtaining an object hierarchy which contains a root object and at least one non-root object, each non-root object having at least the following allocated attributes: an entity type (namely, the type of serialized entity from which the object was generated), a namespace, a qualified name, a link to a parent object; and
creating at least one of the following:
a selective sub-hierarchical serialization, namely, a serialization of a selected proper subset of the object hierarchy;
a mapping of a non-root object of the hierarchy to an XPath-compatible location in a serialization of the hierarchy.

14. The configured medium of claim 13, wherein relationships are present in the object hierarchy between individual objects and respective properties of those objects, and wherein the creating step is consistent in that it maintains those relationships.

15. The configured medium of claim 13, wherein the process further comprises computationally generating the object hierarchy from an XML serialization of the object hierarchy.

16. The configured medium of claim 13, wherein the process further comprises computationally generating the object hierarchy from a serialization of the object hierarchy, and wherein the generated object hierarchy includes as objects class instances in a programming language which has static typing.

17. The configured medium of claim 13, wherein the process further comprises computationally monitoring objects in the object hierarchy and proactively computationally creating the selective sub-hierarchical serialization for a changed object in response to a change detected by the monitoring step.

18. The configured medium of claim 13, wherein the process further comprises computationally monitoring objects in the object hierarchy and proactively computationally creating the mapping to an XPath-compatible location for a changed non-root object of the hierarchy in response to a change detected by the monitoring step.

19. The configured medium of claim 13, wherein the process further comprises changing respective objects in the object hierarchy for at least two concurrent users without giving either user an exclusive lock on the object hierarchy, and computationally creating for each user a respective granular selective sub-hierarchical serialization.

20. The configured medium of claim 13, wherein the process further comprises at least one of the following: running an object hierarchy generation tool to generate the object hierarchy, utilizing a serialization layer to facilitate partial serialization of the object hierarchy.
